(19) United States
(12) Patent Application Publication
(10) Pub. No.: US 2022/0188561 A1
(43) Pub. Date: Jun. 16, 2022

(54) CONTROL DEVICE AND STORAGE MEDIUM

(71) Applicant: KABUSHIKI KAISHA TOKAI RIKA DENKI SEISAKUSHO, Aichi (JP)

(72) Inventors: Kenji NARUMI, Aichi (JP); Hideto OHMAE, Aichi (JP)

(73) Assignee: KABUSHIKI KAISHA TOKAI RIKA DENKI SEISAKUSHO, Aichi (JP)

(21) Appl. No.: 17/503,805

(22) Filed: Oct. 18, 2021

(30) Foreign Application Priority Data
Dec. 11, 2020 (JP) 2020-205778

(51) Int. Cl. G06K 9/32; G06K 9/34; G06K 9/46; G10L 13/00

(52) U.S. Cl. CPC G06K 9/3258; G06K 9/344; G06K 2209/01; G10L 13/00; G06K 9/4604

(57) ABSTRACT

To provide a control device and a program capable of improving convenience of character reading from a captured image.

A control device includes a control unit configured to perform a process of recognizing character groups in a captured image obtained by capturing an image of a periphery of a user, a process of identifying a character group of which a defined priority exceeds a threshold among the recognized character groups, and a process of reading the identified character group by a voice.

### CROSS REFERENCE TO RELATED APPLICATION(S)

This application is based upon and claims benefit of priority from Japanese Patent Application No. 2020-205778, filed on Dec. 11, 2020, the entire contents of which are incorporated herein by reference.

### BACKGROUND

The present invention relates to a control device and a storage medium.

In the related art, a technology for recognizing characters in image data, so-called optical character recognition (OCR), is known. Recognized character information is also output by a voice through voice synthesis.

For example, JP 2009-265246A discloses a technology for outputting character information recognized from image data read by a scanner in a format in which meaning content of characters is preferred by outputting a voice.

### SUMMARY

In the technology of JP 2009-265246A, while voice output of supplementary information irrelevant to meaning content of characters, such as character positions or blank portions (spaces), is avoided, characters in image data can all be read. However, when characters are read from a captured image obtained with a camera which images a periphery and all character information is read, information becomes excessive, and thus it takes some time to obtain necessary information.

Accordingly, the present invention has been devised in view of the foregoing problem and an objective of the present invention is to provide a novel and improved control device and storage medium capable of improving convenience of reading of characters from a captured image.

To solve the foregoing problem, according to an aspect of the present invention, there is provided a control device including a control unit configured to perform a process of recognizing character groups in a captured image obtained by capturing an image of a periphery of a user, a process of identifying a character group of which a defined priority exceeds a threshold among the recognized character groups, and a process of reading the identified character group by a voice.

To solve the foregoing problem, according to another aspect of the present invention, there is provided a computer-readable non-transitory storage medium that stores a program functioning as a control unit that performs: a process of recognizing character groups in a captured image obtained by capturing an image of a periphery of a user; a process of identifying a character group of which a defined priority exceeds a threshold among the recognized character groups; and a process of reading the identified character group by a voice.

According to the present invention, as described above, it is possible to improve convenience of reading of characters from a captured image.

### BRIEF DESCRIPTION OF THE DRAWINGS

FIG. 1 is a diagram illustrating a reading device according to an embodiment of the present invention.

FIG. 2 is a diagram illustrating an example of a captured image captured by an imaging unit included in the reading device according to the embodiment.

FIG. 3 is a block diagram illustrating an exemplary configuration of the reading device according to the embodiment.

FIG. 4 is a flowchart illustrating an exemplary flow of control of the reading device according to the embodiment.

### DETAILED DESCRIPTION OF THE EMBODIMENTS

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### 1. OVERVIEW

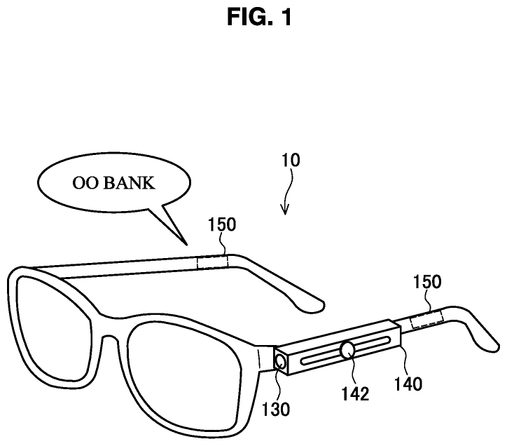

FIG. 1 is a diagram illustrating a reading device 10 (an example of a control device) according to an embodiment of the present invention. The reading device 10 is realized as, for example, a wearable device worn on the head of a user. In the example illustrated in FIG. 1, the reading device 10 is realized as a glasses-type device with a frame in which an imaging unit 130 and a speaker 150 are provided. The imaging unit 130 can perform imaging in a visual line direction of the user when the reading device 10 is worn. An adjustment unit 140 that adjusts a threshold when a reading target is identified is provided in the frame. In the adjustment unit 140, an adjustment knob 142 is slide-operated.

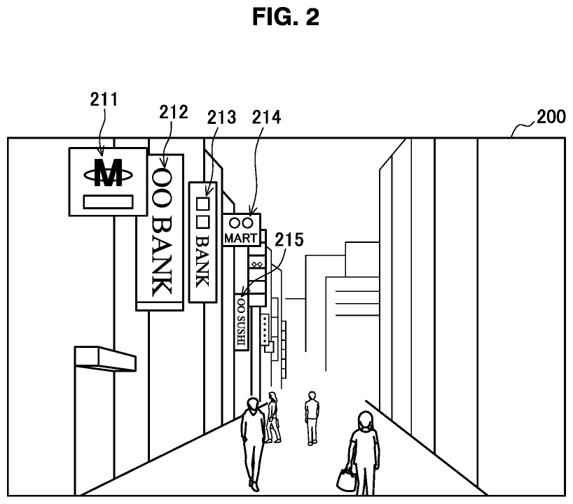

The user wears the reading device 10, for example, when the user is walking along a street. The reading device 10 identifies characters such as a guide plate in a visual line direction (a face direction) of the user from a captured image captured by the imaging unit 130 and performs voice output from the speaker 150. FIG. 2 is a diagram illustrating an example of a captured image 200 captured by the imaging unit 130. As illustrated in FIG. 2, various guide plates are installed on a street, and characters or marks are presented. The guide plates are assumed to be, for example, signboards of stores, signboards for route guidance, and traffic signs.

The reading device 10 according to the embodiment that performs reading of nearby guide plates is assumed to be used by a person who has difficulty recognizing characters or marks through the sense of sight, for example, a visually handicapped person.

### Summary of Problem

Here, when characters are read from a captured image obtained with a camera which images a periphery and all character information is read, information becomes excessive, and thus it takes some time to obtain necessary information.

The reading device 10 according to an embodiment of the present invention has been devised in view of the foregoing problem and is capable of improving convenience of reading of characters from a captured image.

Hereinafter, the reading device 10 according to the embodiment will be described in detail.

### 2. EXEMPLARY CONFIGURATION

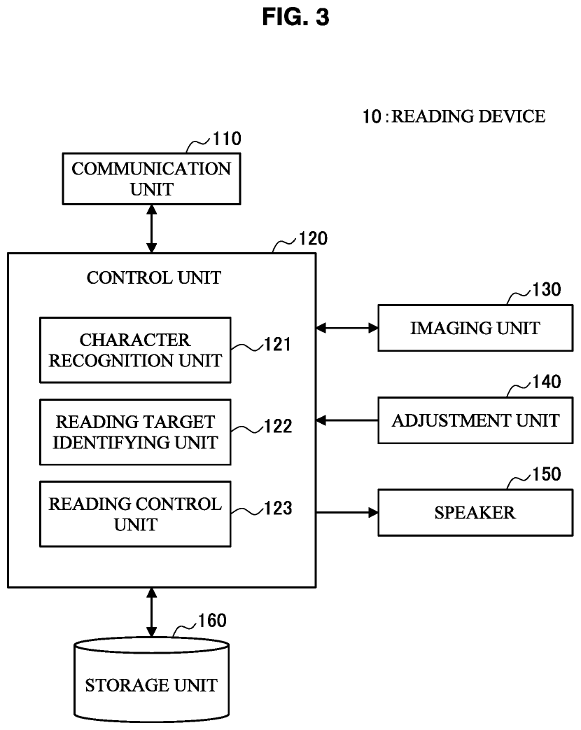

FIG. 3 is a block diagram illustrating an exemplary configuration of the reading device 10 according to the embodiment. As illustrated in FIG. 3, the reading device 10 according to the embodiment includes a communication unit 110, a control unit 120, the imaging unit 130, the adjustment unit 140, the speaker 150, and a storage unit 160.

The communication unit 110 is connected to an external device for communication in a wired or wireless manner and has a function of transmitting and receiving data. As the external device, for example, a smartphone, a tablet terminal, a server, or the like is assumed. The communication unit 110 can communicate with the external device through, for example, a wireless local area network (LAN), Bluetooth (registered trademark), Wi-Fi (registered trademark), or the like.

The control unit 120 functions as an arithmetic processing device or a control device and controls all or some of operations of constituent elements based on various programs recorded on a read-only memory (ROM), a random access memory (RAM), the storage unit 160, or a removable recording medium. The control unit 120 can be realized by, for example, a processor such as a central processing unit (CPU) or a micro controller unit (MCU).

The control unit 120 can function as a character recognition unit 121, a reading target identifying unit 122, and a reading control unit 123. The character recognition unit 121 recognizes characters from a captured image captured by the imaging unit 130. An algorithm for character recognition is not particularly limited. For example, an optical character recognition (OCR) function in which optical character recognition (OCR) or an artificial intelligence (AI) technology is incorporated may be used. The imaging unit 130 recognizes characters of each group from the captured image. The characters of each group are also referred to as a character group. For example, for the character groups, in the case of a captured image 200 illustrated in FIG. 2, regions of guide plates are extracted from the captured image 200 through edge detection, and characters in the regions of the guide plates are recognized as lumps of characters (for example, character groups 211 to 215 illustrated in FIG. 2). In the embodiment, the “character groups” also include information obtained by forming marks (figures) of logos or the like of stores as characters. In the character recognition, the character recognition unit 121 recognizes predetermined logos, marks, and the like through image processing (for example, pattern matching) and converts the logos, marks, and the like into defined characters.

The reading target identifying unit 122 identifies reading targets from the recognized character groups. By setting some of the identified character groups as reading targets rather than all of the character groups recognized from the captured image, excess of information at the time of outputting of a voice can be reduced and a time taken until voice guides (reading) are fully heard can be reduced, and thus it is possible to improve convenience of the reading device 10. The reading target identifying unit 122 identifies a character group of which a defined priority exceeds a threshold among the recognized character groups.

The defined priorities are, for example, marks or signs in which importance is set step by step or sizes of characters. The importance of the marks or signs may be preset or may be set arbitrarily by the user. For example, the user can also set marks or signs which the user does not want to overlook so that the importance of the marks or signs is high. The setting can be performed using, for example, a display screen of a smartphone connected to the reading device 10 for communication.

The “threshold” may be preset or may be appropriately adjusted by the user. As an example of a method of adjusting the threshold, magnitude of the threshold can be adjusted, as illustrated in FIG. 1, for example, by moving the adjustment knob 142 of the adjustment unit 140 forward and backward (in the front and rear directions along the frame of the glasses). For example, a middle portion of a slide provided in the adjustment unit 140 may be set as a reference value, the threshold may increase as the adjustment knob 142 is moved in the front direction, and the threshold may be decreased as the adjustment knob 142 is moved in the rear direction. The reading target identifying unit 122 recognizes a position of the adjustment knob 142 to appropriately adjust the threshold. Recesses or projections (for example, click pins) may be provided at equal intervals along a movement path of the adjustment knob 142 on the slide of the adjustment unit 140 and the position of the adjustment knob 142 may be transferred to the user in a tactile manner. The control unit 120 may perform control such that an adjusted value is notified of by outputting a voice from the speaker 150. The structure of the adjustment unit 140 is exemplary and is not limited to the example illustrated in FIG. 1. The adjustment unit 140 may be of a dial type, a button type, or a touch type. In the example illustrated in FIG. 1, the adjustment unit 140 and the imaging unit 130 are integrated, but the present invention is not limited thereto. The adjustment unit 140 may be provided in an external device (for example, a smartphone or a switch device) connected to the reading device 10 for communication.

A case in which a character size is used as an example of the priority will be described. The reading target identifying unit 122 identifies a character group of which a character size exceeds a threshold in the recognized character group as a reading target. The threshold of the character size may be a pixel (px) or a point (pt). Thus, only a text group equal to or greater than a given size can be identified as a reading target. By identifying the reading target in the character group equal to or greater than the given size, it is possible to read a guide plate closer to the user relatively preferentially.

The reading control unit 123 voices the text group identified by the reading target identifying unit 122 through voice synthesis and performs reading control such that the text group is output as a voice from the speaker 150.

The imaging unit 130 has a function of performing imaging in a visual line direction of the user. The imaging unit 130 continues the imaging and outputs a captured image to the control unit 120. The imaging unit 130 can be provided to perform the imaging in the visual line direction of the user, and thus text information in a traveling direction of the user (a direction in which his or her face is oriented) can be acquired. Here, for example, the imaging unit 130 performs the imaging in the visual line direction of the user, as described above, but the embodiment is not limited thereto. The imaging unit 130 may be disposed to image a periphery of the user including at least the visual line direction of the user.

The adjustment unit 140 has a function of adjusting the threshold. For example, the adjustment unit 140 includes a sensor that detects a position of the adjustment knob 142 and outputs sensing data to the control unit 120. A method of adjusting the threshold is not limited to the method in which a manual manipulation is assumed to be performed by the user, as described above. A voice may be input using a microphone (not illustrated) included in the reading device 10. When the priority is the size of a character (a character size), a reference value (a value before the adjustment) of the threshold used to identify a reading target may be a character size which can be identified by a person who has predetermined vision (for example, vision of 0.6). The reference value of the threshold can be appropriately preset in accordance with an angle of field or a resolution of the imaging unit 130.

The speaker 150 has a function of outputting a voice. For example, as illustrated in FIG. 1, the speaker 150 is provided in a right or left frame of a glasses-type device that realizes the reading device 10. The speaker 150 may be a bone conduction speaker.

The storage unit 160 is configured to store various kinds of information. For example, the storage unit 160 stores a program, a parameter, and the like which are used by the control unit 120. The storage unit 160 may store a processing result by the control unit 120. Content of information stored in the storage unit 160 is not particularly limited. The storage unit 160 can be realized by, for example, a read-only memory (ROM), a random access memory (RAM), or the like. As the storage unit 160, for example, a magnetic storage device such as a hard disk drive (HDD), a semiconductor storage device, an optical storage device, a magneto-optical storage device, or the like may be used.

The configuration of the reading device 10 according to the embodiment has been described. The configuration of the reading device 10 according to the embodiment is not limited to the configuration illustrated in FIG. 3. For example, the reading device 10 may be configured by a plurality of devices. The reading device 10 may not include the communication unit 110. The reading device 10 may not include the adjustment unit 140.

At least some of the functions of the control unit 120 may be realized by a server connected to the reading device 10 for communication, a smartphone carried by the user, or the like.

The reading device 10 realized by a glasses-type device illustrated in FIG. 1 has been described, but the embodiment is not limited thereto. For example, the reading device 10 may be realized by a type of device worn around the neck of the user (the imaging unit 130 performing imaging in the front direction is mounted) and an earphone or a headphone (an example of the speaker 150).

### 3. OPERATION PROCESS

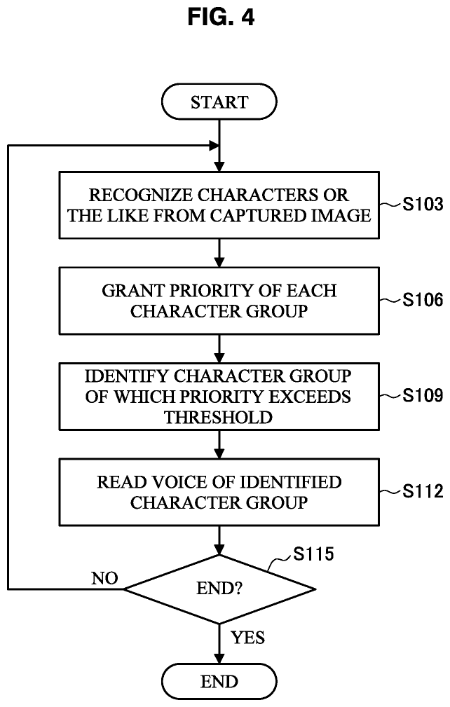

FIG. 4 is a flowchart illustrating an exemplary flow of control of the reading device 10 according to the embodiment. As illustrated in FIG. 4, the character recognition unit 121 first recognizes characters or the like from a captured image captured by the imaging unit 130 (step S103). For example, the character recognition unit 121 extracts regions of one or more guide plates from the captured image and recognizes characters in the region of each guide plate as character group. When the character recognition unit 121 recognizes a predetermined mark from the region of the guide plate, the character recognition unit 121 converts the mark into characters corresponding to the mark.

Subsequently, the reading target identifying unit 122 grants a priority of each character group (step S106). When the priority is a character size, a character size recognized from the captured image is set as the priority. When the priority is importance, importance corresponding to a recognized character or mark is set as the priority.

Subsequently, the reading target identifying unit 122 identifies the text group of which the priority exceeds the threshold as a reading target (step S109).

Subsequently, the reading control unit 123 performs voice reading of the character group identified by the reading target identifying unit 122 (step S112).

Then, the control unit 120 repeats the foregoing steps S103 to S112 until an ending condition is satisfied (step S115). The ending condition is, for example, a condition that power (not illustrated) of the reading device 10 is turned off.

The operation process according to the embodiment has been described above. The operation process illustrated in FIG. 4 is exemplary and the present invention is not limited thereto.

### 4. SUPPLEMENTS

Next, reading control according to the embodiment will be supplemented.

The reference value (the value before the adjustment) of the threshold used to identify a reading target may be preset in accordance with an environment or may be automatically adjusted appropriately. For example, the threshold may be set in accordance with whether the environment is indoors or outdoors. The reading device 10 recognizes whether the environment is indoors or outdoors based on an analysis result of positional information or a captured image, a voice input from the user, a switch operation, or the like, decreases the threshold when the environment is indoors (because recognized character information is assumed to be relatively little), and increases the threshold when the environment is outdoors (because the recognized character information is assumed to be relatively much). The threshold may be set in accordance with a nation. The reading device 10 may set the threshold in accordance with a selected nation (or a working language) when the priority is the size of a character. For example, in consideration of a tendency for alphabetic characters to be relatively smaller than Japanese characters (kana and kanji) in guide plates, when “English” is selected, the threshold may be set to be less than when “Japanese” is selected.

When the threshold is adjusted (changed) during or after the reading, the reading device 10 may perform the reading from the beginning again or may additionally continue to read differences.

When the reading device 10 reads the identified character groups, the reading device 10 may read the character groups in a descending order of the priority (for example, in order from the largest character size). Thus, the character groups can be read in order from a relatively closer location or a guide plate noticed at the time of visual recognition, and thus the user can ascertain which guide plate is closer and which guide plate is noticed at the time of visual recognition.

The reading device 10 may further include a distance sensor. In this case, the reading target identifying unit 122 of the reading device 10 can also recognize character groups of guide plates located within a predetermined distance as reading targets. Thus, it is possible to read the guide plates within the predetermined distance.

The reading device 10 may be mounted in a vehicle. The reading device 10 can support a driver or can call attention by recognizing characters of traffic signs or signboards from a captured image captured in a traveling direction of the vehicle and reading the character groups exceeding the threshold. In this case, the control unit 120 of the reading device 10 may be realized by an electronic control unit (ECU) mounted in a vehicle, a microcomputer mounted on an ECU, or the like.

### 5. CONCLUSION

Preferred embodiments of the present invention have been described in detail above with reference to the appended drawings, but the present invention is not limited thereto. It should be apparent to those skilled in the art that various changes and alterations may be made within the scope of the technical spirit described in the appended claims, and the changes and alternations are, of course, construed to belong to the technical scope of the present invention.

For example, the reading device 10 is mounted in a vehicle, as described above, but the vehicle is an example of a moving object. The moving object according to the embodiment is not limited to a vehicle and may be a ship (for example, a passenger ship, a cargo ship, or a submarine) or an aircraft (for example, an airplane, a helicopter, a glider, or an airship). The vehicle is not limited to an automobile and may be a bus, a motorcycle, a locomotive, or a train. The moving object is not necessarily limited to the foregoing examples and may be any object which can move. The mounting of the reading device 10 in a moving object is merely exemplary and the reading device 10 may be loaded in an object other than a moving object. At least a part of the configuration of the reading device 10 may be mounted in a moving object and the rest of the configuration may be mounted in an object other than the moving object.

The content described in the above-described embodiment and supplements may be combined.

The advantageous effects described in the present specification are merely explanatory or exemplary and are not limitative. That is, the technology according to the present disclosure can obtain other advantageous effects apparent to those skilled in the art from the description of the present specification in addition to or instead of the foregoing advantageous effects.

In hardware such as a CPU, a ROM, and a RAM embedded in a computer, one or more programs that have the same functions as the reading device 10 can also be generated and a computer-readable recording medium on which the one or more programs are recorded can also be provided.

What is claimed is:

1. A control device comprising:
a control unit configured to perform a process of recognizing character groups in a captured image obtained by capturing an image of a periphery of a user, a process of identifying a character group of which a defined priority exceeds a threshold among the recognized character groups, and a process of reading the identified character group by a voice.

2. The control device according to claim 1, wherein the control unit identifies a character group of which a character size which is the defined priority exceeds the threshold among the recognized character groups.

3. The control device according to claim 2, wherein the threshold is a character size which is able to be identified by a person who has predetermined vision.

4. The control device according to claim 1, wherein the control unit performs a process of reading the identified character group in descending order of the priority.

5. The control device according to claim 1, further comprising:
an adjustment unit configured to receive an adjustment of the threshold.

6. The control device according to claim 1, further comprising:
an imaging unit configured to perform imaging at least in a visual line direction of the user; and
a voice output unit configured to output the voice.

7. The control device according to claim 1, wherein the control device is a wearable device worn by the user.

8. The control device according to claim 1, wherein the control unit extracts regions of one or more guide plates from the captured image and recognizes characters in the region of each guide plate as a character group.

9. The control device according to claim 8, wherein the control unit performs a process of recognizing a predetermined figure from the region of the guide plate in the recognition of the character group in the captured image and converting the predetermined figure into determined characters.

10. The control device according to claim 1, wherein the control device is a device mounted on a moving object.

11. A computer-readable non-transitory storage medium that stores a program functioning as a control unit that performs:
a process of recognizing character groups in a captured image obtained by capturing an image of a periphery of a user:
a process of identifying a character group of which a defined priority exceeds a threshold among the recognized character groups; and
a process of reading the identified character group by a voice.
